(19) United States
(12) Patent Application Publication
(10) Pub. No.: US 2022/0138467 A1
(43) Pub. Date: May 5, 2022

(54) AUGMENTED REALITY UTILITY LOCATING AND ASSET MANAGEMENT SYSTEM

(71) Applicant: ARUTILITY, LLC, Mason, MI (US)

(72) Inventor: Joseph Steven Eastman, Mason, MI (US)

(73) Assignee: ARUTILITY, LLC, Mason, MI (US)

(21) Appl. No.: 17/516,682

(22) Filed: Nov. 1, 2021

Related U.S. Application Data
(60) Provisional application No. 63/107,772, filed on Oct. 30, 2020.
(60) Provisional application No. 63/121,850, filed on Dec. 4, 2020.
(60) Provisional application No. 63/199,231, filed on Dec. 15, 2020.

(51) Int. Cl. G06K 9/00; G06T 19/00

(52) U.S. Cl. CPC G06K 9/00671; G06T 19/006

(57) ABSTRACT

An augmented reality (AR) system is provided for visualizing, displaying, and management of utility assets. The system includes a mobile device having a display, a camera, a processor, a controller, and a wireless communication module. The display is coupled to the camera configured for displaying a base image and view from the camera. A mobile application is hosted on the mobile device for processing asset data corresponding to existing assets surrounding a location of the mobile device. The asset data corresponds to one or more utility lines and the mobile application is configured for determining relative distance data from the mobile device to the asset and generating an overlay image viewable through the display over an existing camera view in AR. Indicia of the asset is displayed on the mobile device. The indicia include dashed, colored, and/or solid lines, and shapes corresponding to virtual assets.

### CROSS REFERENCE TO RELATED APPLICATION

Priority is claimed to U.S. Provisional Application No. 63/107,772 filed Oct. 30, 2020, which is incorporated herein by reference in its entirety. Priority is also claimed to U.S. Provisional Application Nos. 63/121,850 filed Dec. 4, 2020 and 63/199,231 filed Dec. 15, 2020, which are incorporated by reference in their entirety.

### TECHNICAL FIELD

The present disclosure relates generally to the field of augmented reality (AR) asset management and visualization systems and methods, and more particularly to systems configured to locate, display, and manage assets through AR using mobile devices.

### DESCRIPTION OF RELATED ART

Asset locating and management is an important function of public and private utility companies and municipalities. This is especially true for those assets that are underground or not readily visible like pipes and electrical lines. Public and private utility providers will typically own, operate, or both, some combination of water, power, gas, electric, steam and chilled water utilities. These providers have specific functions and responsibilities for which they are obligated to perform. Those responsibilities range from responding to utility staking requests to preparing an asset inventory for an approved asset management plan. Often, these services are critical to any type of construction, development, infrastructure and/or renovation project. More efficient utility staking and locating solutions are often sought.

U.S. Pat. No. 10,037,627 to Hustad, et al. provides for an augmented visualization system for hidden structures. The system includes a camera operable to capture a base image of a field of view. A spatial sensor is configured to sense a position of the camera and to generate positional information corresponding to the position. A controller is in communication with the camera, the spatial sensor, and a data source having stored geospatial data. The controller is configured to determine when the geospatial data corresponds to a location in the field of view of the camera based on the positional information. The controller is also configured to generate a geospatial image in response to the controller determining that the location corresponding to the geospatial data is in the field of view. A display is in communication with the controller and is operable to display a composite image in which the geospatial image is overlaid with the base image.

A need remains for improved systems and methods for locating, managing, and visualizing accurate information and assets whether visible or not, above ground or below ground, and real or hypothetical.

### SUMMARY

An augmented reality (AR) system for visualizing, displaying, and management of utility assets incudes: (a) a mobile device having a display, a camera, a processor, a controller, and a wireless communication module, the display coupled to the camera configured for displaying a base image and view from the camera; (b) a mobile application hosted on the mobile device and executed by the controller configured for processing asset data including at least one of location, identification, and depth data of the asset, the asset data corresponding to one or more existing assets surrounding a location of the mobile device, wherein the asset data corresponds to one or more utility lines and the mobile application is configured for determining relative distance data from the mobile device to the asset and generating an overlay image as an AR image viewable through the display over the base image; (c) indicia for indicating identity and location of the asset corresponding to the processed location data and overlayed on the display, wherein the indicia includes dashed, colored, solid lines, and shapes corresponding to virtual assets; and (d) a function menu configured to be accessed on the display to optionally add virtual overlays on the display including a virtual asset.

The controller is configured to be updated with location and view data in real-time to adjust for the corresponding relative distance from the mobile device and the asset. In an example, the display is a touchscreen of a mobile smartphone, smart tablet, or mobile computer coupled to an integrated or external camera. The asset data can include geospatial location data.

In an example, the AR system further includes a calibration tool. The calibration tool is configured to align for orientation of the overlay image with corresponding real objects provided on the display. The mobile application is configured to allow for manual or remote data input to update location data of the asset. In a further example, the mobile application is configured for inputting virtual assets onto the display for determining feasibility and functionality of the virtual asset in cooperation with an existing location and utility line. The mobile application, using the wireless communication module, is configured to wirelessly communicate location and distance data associated with virtual assets, including screenshots and virtual hypothetical modifications to an existing asset system or configuration.

The system allows for hidden and unhidden assets to be visible on the overlay image and hidden utility lines are shown in both solid and dashed lines on the display. In an example, hidden water lines are virtually displayed and overlayed in solid and dashed blue lines, hidden gas lines are displayed and overlayed in sold and dashed yellow lines, and hidden power lines are displayed and overlayed in solid and dashed red lines, on an image view in real-time on the display. In an example, the hidden asset includes location and depth data as an AR image showing a solid line and a corresponding dashed line of a matching indicia to provide relative perspective to actual location above ground identification. In yet another example, further including depth indicators are connected to a virtual asset indicia.

The mobile application further includes a functional menu accessible on the display for generating a measuring tool, a calibration tool, or a virtual asset to be overlayed on the display. The overlay display is configured to be adjusted in real-time responding to positioning of the camera relative to its position in the base image. The camera and the mobile application are configured for detecting a ground surface to maintain a continuous visual display of the hidden asset. The mobile application includes computer vision algorithms executed on the controller to generate a 3D model of the camera within its surroundings and further includes computer vision configured to track movement of the camera and the camera position relative to a location of the camera for tracking camera location and orientation relative to the surrounding objects. The 3D model corresponds to the base image and tracks detected points within the image, the relative position of those points from each other, and is configured to track those points as the computer vision algorithms compares the points from frame to frame to the points in the base image at a frame refresh rate. The system can further include an annotation, drawing object, and note tool configured to allow manual inputs to be provided on the display and the overlayed AR image.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate systems and method(s) of use for the present disclosure constructed and operative according to the teachings of the present disclosure.

FIG. 1 is a schematic illustration of a virtual camera within a 3D model representing the 3D model at a specified position and orientation corresponding to the position and orientation of a camera of a mobile device.

FIG. 2A shows a mobile device having a display screen for displaying exemplary virtual utility lines as underground assets, the virtual utility lines appear overlayered as augmented reality on top of a real image view from the camera of the mobile device corresponding to the actual position of those utility lines in the real world.

FIGS. 2B-2C show a first and second viewing angle, respectively, of an example augmented reality display of virtual utility lines connected to a virtual asset overlayed on an actual image captured by the camera of the mobile.

FIG. 3 shows dashed lines and depth indicators on a ground surface, directly over or under certain assets to communicate the location of the asset to the user whereby the lines are displayed from the asset to its dashed line representation on the ground surface to indicate to the user which asset is represented by which dashed line on the ground surface.

FIG. 4 shows annotations that are inputted by a user through touch events or application features whereby at least some of the annotations can include 3D objects to be incorporated into the original 3D model.

FIG. 5A shows an example screenshot related to taking measurements in augmented reality.

FIG. 5B shows a view of a 3D model with above ground assets (i.e., fire hydrant and valve) displayed at their actual geographic locations.

FIG. 6A shows a calibration screenshot that allows a user to place a virtual object at a physical location within an image corresponding to the real-world using augmented reality visualization.

FIG. 6B shows a top view of the calibration view of 6A wherein once the user has placed at least one object in the 3D scene, an aerial image can be loaded at that location providing the user with a bird's eye view, the aerial imagery can be aligned so that the same point on the aerial image aligns with the 3D object previously placed to ensure the 3D scene is correctly positioned and oriented with the real-world.

FIG. 7 shows a calibration screenshot of an aerial image displayed on a ground surface in an augmented reality view wherein the aerial image is loaded into a 3D scene where north on the image is oriented with north in the 3D scene and the 3D scene can then be rotated and positioned so that the features in the aerial image align with the features in the real-world to ensure the 3D scene is correctly positioned and oriented with the real-world.

The various embodiments of the present disclosure will hereinafter be described in conjunction with the appended drawings, wherein like designations denote like elements.

### DETAILED DESCRIPTION

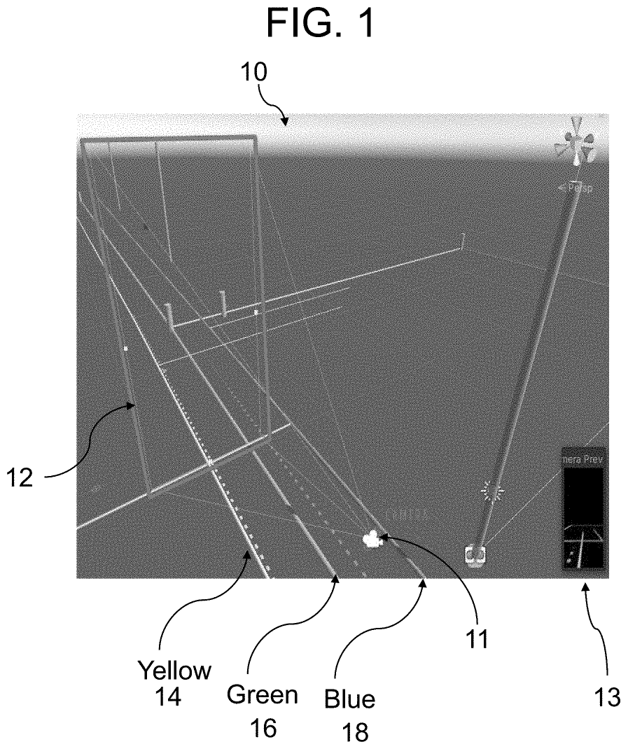

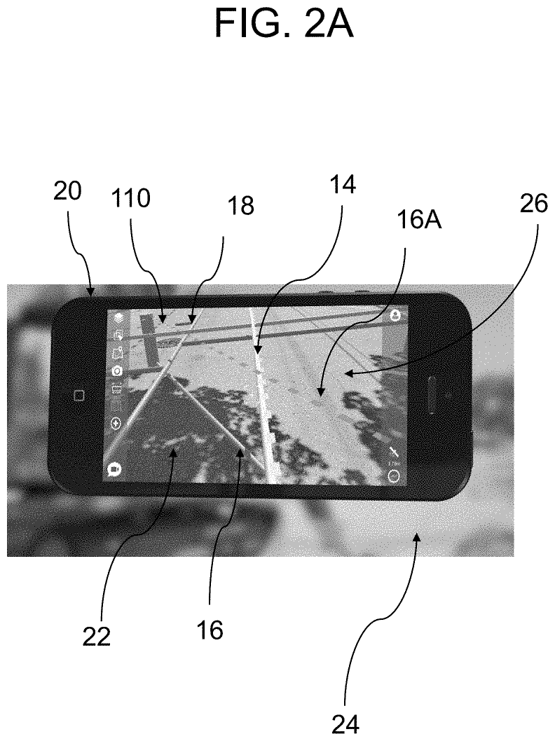

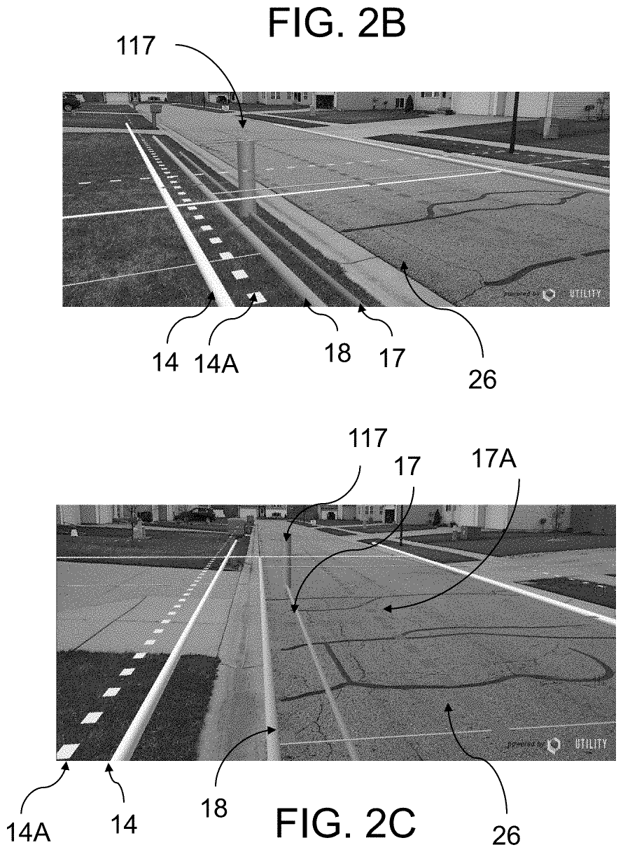

Referring to FIGS. 1-7, the present disclosure provides for systems and methods configured to load asset information around a determined location to generate a three-dimensional (“3D”) model of the assets (See FIG. 1) as a base image. The asset information includes asset data like geospatial data. The system can be provided on a mobile device (e.g., a smart phone, smart tablet, or mobile computer) like the mobile device 20 shown in FIG. 2A. In this example, the mobile device 20 includes standard smart device (e.g., a smartphone, smart tablet, mobile computer, etc.) features like a wireless communication module for receiving and transmitting information through a wireless communication network or system (e.g., WIFI, 4G, 5G, and/or a satellite communication system) along with a user interface (UI) display 22, a camera, and an internal controller and processor. The camera can be integrated into the mobile device or external and coupled to the mobile device. The camera includes known camera features and provides a view through one or more lenses. In another example, a dedicated digital camera can be used that is not fully integrated with the mobile device but is coupled or is configured to interact and display a captured or real-time image that is visible on the display of the mobile device or visible remotely at a remote location.

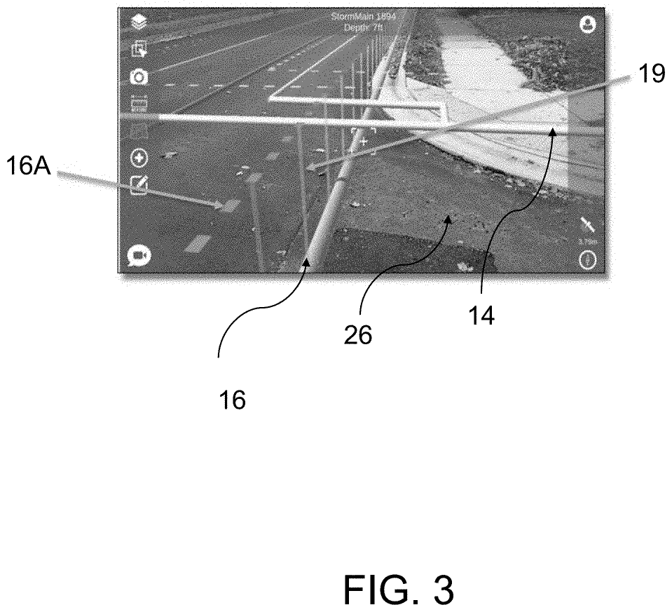

In an example, a system according to the present disclosure allows for virtual assets to be placed in a parent container object like the model shown in FIG. 1. The virtual assets represent real assets in the physical space/area surrounding the camera, which can be hidden. To place the assets at a correct height, an application hosted on the mobile device or accessible by the mobile device is provided that utilizes computer vision algorithms to detect a ground surface around a user at an arbitrary point. Computer vision algorithms are well known in the art and any suitable algorithm is contemplated within the scope of the present disclosure. The 3D model can then adjust a y-position to be placed at a measured distance below the camera (i.e., controller) of the mobile device (See, FIGS. 2B, 2C, and FIG. 3). The computer vision algorithm determines the distance from the camera to the ground and uses that measurement to adjust the elevation of the assets within the model. Mobile devices typically include a touchscreen display with typical touchscreen functionality. The features of the system can thus be efficiently utilized by a user's direct physical touch, through a stylet or via function keys if a keyboard is provided.

FIG. 1 illustrates a base 3D model 10 that is generated as a first step of the AR system. Using a smart device (shown in FIG. 2), in this example, virtual assets (14, 16, and 18) are loaded into the base model 10. A camera field of view is shown by a frame 12 that is outlined to generate a preview of what is possible to be seen with a camera which is shown in the model as a virtual camera 11. One or more virtual assets 14, 16, and 18 are generated that represent real assets at or near their actual locations within the field of view 12. In this example, the assets represent utility lines and can be color coded to provide a visible indicium for the variety of assets. As shown, utility line 14 is yellow, utility line 16 is green, and utility line 18 is blue. Virtual camera 11 is overlayed in the base 3D model 10 to orient a mobile device 20 with respect to the virtual assets and the field of view 12. In this display, a secondary preview display 13 is shown in a corner to provide a camera preview. Base 3D model 10 is configured to provide a 3D view of relative relationships of a group of corresponding virtual assets.

FIG. 2A shows virtual assets 14, 16, and 18 overlayed on a backdrop or background generally visible through the camera of mobile device 20, which generates a base image 110. Whatever is in view of the camera, is considered a base image 110. The 3D model 10 can be scaled in real-time from a start at a 1:1 scale with real-world background 24 perceived through the camera of the mobile device 20 or adjusted to be zoomed or shrunk. Based on the properties of the camera lens, the 3D model 10 can be scaled and displayed in a way that sufficiently aligns, orientates, and adjusts with surrounding objects in the base image110. The camera then replicates the real-world camera view (i.e., base image 110) onto the controller and shows it on the display 22 with the base 3D model 10 overlayed onto the image. A “real” asset under the ground can be represented on the display as a virtual object like a cylinder 117 (FIG. 2B) connected to a utility line 17 of the same color and a corresponding dashed line 17A. Object 117 can be any utility-based asset like a manhole cover or fire hydrant. This helps with visualization of assets above ground and their location below ground and the corresponding connected utility line. In this example, the asset 117 and lines 17/17A have a matching indicia color.

The present disclosure further provides for a display 22 with one or more dashed lines like corresponding green dashed line 16A or solid lines (14, 16, 18) on a ground surface 26 to represent where an asset would be located if it were on the ground surface. (FIGS. 2B, 2C, 3, 4A-4B). This allows for more accurate locating of the assets as it provides a better perspective in relation to the user's point of view.

Geospatial data is data that includes coordinates on the earth's surface. Data that does not include geospatial data can still be utilized by the systems and methods of the present disclosure. The present disclosure obtains data that is relative distances from the user's actual physical location as indicated by the mobile devices GPS location. The data that gets sent to the controller of the mobile device is used to generate a 3D model. In this example, this data is all relative, not geospatial data. For example, a manhole location would come to the controller as distance x=-5 ft, distance z=10 ft, etc. Geospatial data provides a latitude and longitude in some coordinate system in addition to the other data as it relates to a particular asset or location.

The present disclosure provides for computer vision algorithms incorporated into the system and executed into a program hosted or performed through the controller of the mobile device. Rather than relying solely on sensor inputs, like compass, accelerometer and gyroscope, etc., the present disclosure provides for computer vision to track movement in the real-world and therefore update the position of the camera in the 3D model and the refreshing of the base image. (See FIGS. 1, 2A, 2B and 2C). This results in improved tracking of the camera's position and orientation and an overall improved user experience for the AR display and overlay on a real-world image (i.e., the camera view).

The computer vision algorithm compares the base image from frame to frame (e.g., 30 to 60 frames per second) and is configured to detect a plurality of points in the image. The points are then tracked from frame to frame. Some algorithms will assign values to each point based on quality. In an example, the quality can be based on how identifiable those points are relative to other points or features within the base image. As the real camera moves around, thus changing the view, certain points on surrounding objects are detected and tracked. This allows for movement of the virtual camera 11 to accurately track and move throughout the base 3D model which is generated by the system and overlayed onto the base image.

The virtual assets are overlayed onto the actual view from the camera and allows for view changes and adjustments as the camera moves. Based on these changes, the controller is configured to determine the cameras position and orientation relative to the surrounding area. Additionally, the controller is configured to obtain the user's geographic location from the device itself or an external device and adjust within the base 3D models. This occurs relative to the controller, as needed to maintain accuracy and correct for any drift that has resulted from the computer vision tracking algorithms. This also allows the controller to adjust the orientation of the base 3D model as needed from time to time to ensure the digital data is oriented correctly with the real-world to match the 3D asset location with its physical location in the real-world. Moreover, the system does not require the presence of a known base object in the real world to act like an anchor to guide, orientate, or rely upon to effectively function. As the camera view moves and adjusts, new points can be identified each time to reset the base image within the base 3D model.

The present disclosure provides for a system and method of displaying utility line and asset information in augmented reality (AR) in its actual geographic location, including an indicia corresponding to its actual depth below or above the ground surface via depth indicators 19 as shown in FIG. 3. This is achieved by displaying a 3D representation of an asset at its actual depth below or above the ground surface. For example, a sewer main is represented by a 3D cylinder and is displayed in its actual geographic location using AR. A dashed or solid line is shown on the ground surface that represents that asset's horizontal location in the world. That data corresponding to the utility lines or asset information is obtained from various sources, whether that's a geographic information system, keyhole markup language (KML) file, or other file type containing geo-location information. This data is then parsed, and the assets or utility lines are displayed at their location in the real-world. The user's latitude and longitude data (obtained through the mobile device either through global positioning system (GPS) or otherwise and running the asset information through the algorithms configured into a computer program hosted on the mobile device or accessed through a cloud program. The asset is then displayed at the appropriate location in relation to the user. The relative positions of the user to physical assets is then calculated from the position information received from the controller and returns these relative positions back to the controller to create a 3D model of those assets. The system consumes data that includes the latitude and longitude of each asset. A starting latitude and longitude are set, whether that is the users GPS coordinates from their hardware or a known latitude and longitude that can be manually entered. The northing and easting of each asset is then determined in relation to the user's location or the location of the manually entered latitude and longitude. The asset is then displayed at the appropriate distance and location from the user based on those calculations.

Indicia corresponding to depth or height of a particular asset, referred to as “depth indicators” 19 (FIG. 3), is also displayed that shows which 3D asset is associated with which dashed or solid line on the ground surface. This shows a cross section of the utility to show how deep or how high that asset is compared to its surroundings. Moreover, each type of asset line, like a power line, a water line, a gas line, etc., can be designated a different indicia that is viewable and distinguishable on the AR overlay display. For example, a water line can display in a solid blue line 18 where a gas line is shown in yellow 14/14A. The dashed line can show depth as it is spaced away from the corresponding line in an equal color. (See FIGS. 3).

The present disclosure further provides for a method that adjusts the assets elevation as the user moves around their environment (FIGS. 2B and 2C). For example, walking down a hill, if no adjustments were made, and the user began walking down the hill, the assets would maintain the same elevation as where the user started and the user would see through the visual display, themselves walking underneath the assets, breaking, distorting, or compromising the AR illusion. This is a common problem with AR solutions. As the user is walking around in their environment, the mobile application is configured for detecting the ground surface at all times using the same computer vision algorithms as previously discussed. The controller is able to determine the height of the camera above the ground surface and adjust the assets elevation to match the ground surface elevation in real time or almost real time. By doing this on a consistent basis, the vertical location of the assets can be continuously updated to maintain an accurate vertical location in relation to the user's current position. This enhances the display, user interface, and user experience providing an effective solution for asset management, locating, and decision making. It reduces time and money required to find assets and evaluate whether those assets interfere with others in a surrounding space without digging out maps, marking off lines or physical measuring. These assets are below ground and thus difficult to find, track and identify relative to a user's actual physical location. An effective AR overlay solution drastically reduces the time, accuracy, and effort required to complete these tasks.

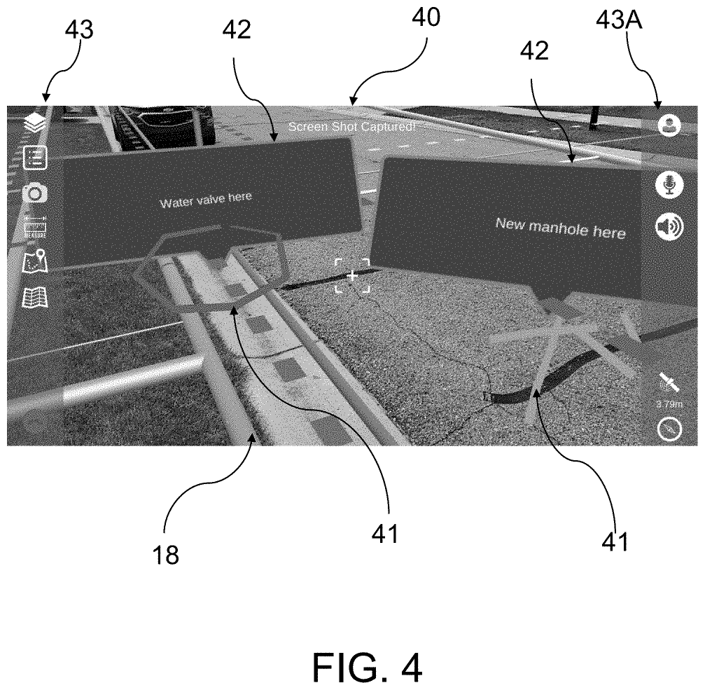

Referring to FIG. 4, an AR display image 40 is shown. The present disclosure further provides for remote assistance functionality which allows a user to share their augmented reality view with a remote user. That remote user is able to leave drawings 41 and annotations 42 that stick in their place corresponding to real-world locations. This allows for combining the augmented reality annotations and drawings with augmented reality asset visualizations and allowing users to share their view with a remote user. In the display 40, one or more function menus 43 and 43A can be accessed to conveniently make or modify the AR overlay image including the adding or removing of drawings 41 and annotations 42.

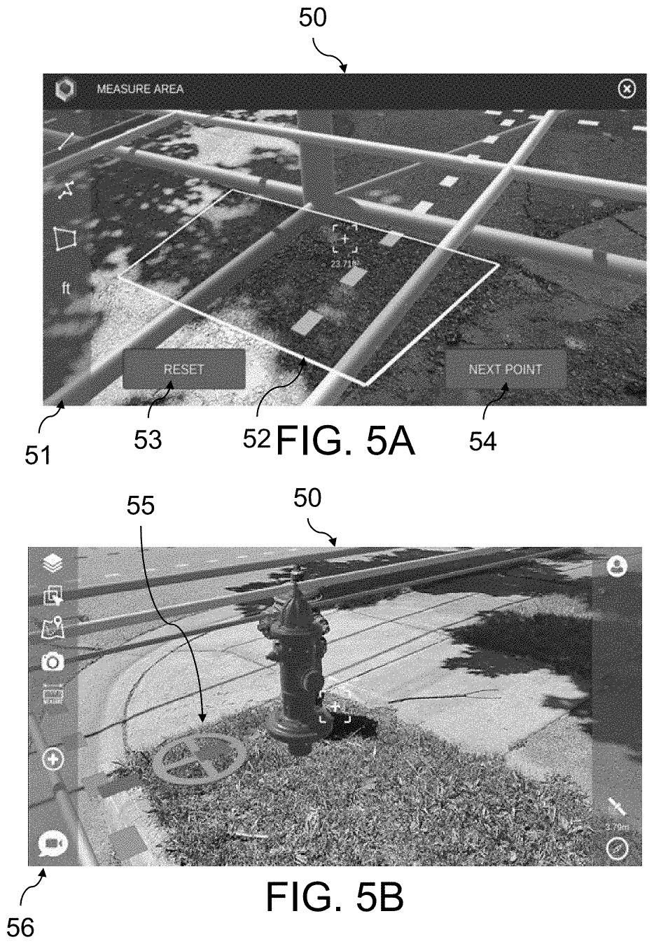

Referring to FIGS. 5A-5B, the present disclosure still further serves as an effective asset management tool, particularly for utility purposes, that allows for distance and area measurements in augmented reality. The measurements can be combined with providing a virtual visual aid of one or more assets in AR. A virtual “new” asset can be introduced into a visual display in AR and placed near a real asset to evaluate a potential instillation and the like. In FIG. 5A, a measuring tool 50 is shown as part of the system and accessible from the mobile device. The measuring tool 50 can include a function menu 51. In this example, the function menu is positioned along a left-hand side portion of the display. This can allow for a variety of measuring techniques to be deployed like a straight-line measurement, or a distance between multiple points, or an area measurement like the one shown by a two-dimensional fully closed shape 52. In this example, shape 52 is a trapezoid, however, squares, triangles, circles, rectangles, and others are contemplated and within the scope of this disclosure. The shape 52 can generate an area measurement to assist with planning and management of a desired asset and show the overlay in a designed shading to compare its relationship to surrounding utility lines, also shown in AR.

Functional features, like RESET button 53 and NEXT POINT button 54, can also be shown and accessed on the display. For example, a mobile device employing the system of the present disclosure can point the camera of the mobile device at a real location for a new hydrant 55, using the function keys of new asset menu 56 shown in FIG. 5B, add that hydrant, capture a latitude and longitude of that hydrant's location, and send that information/data back to the system to identify and track geographic information. This further allows for assessment of whether the virtual new asset will conflict with existing systems, assets, or required utility lines, while providing a visual representation of how it may look or function and/or what problems may result with placing the asset at that location.

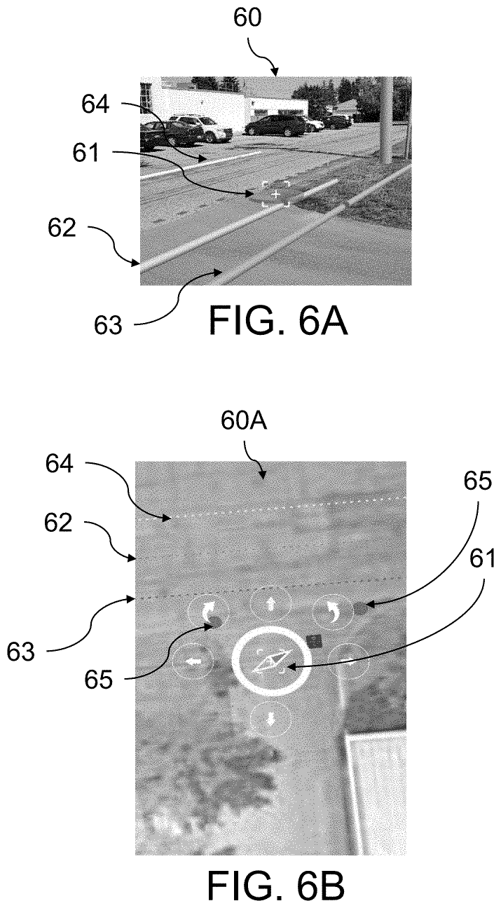

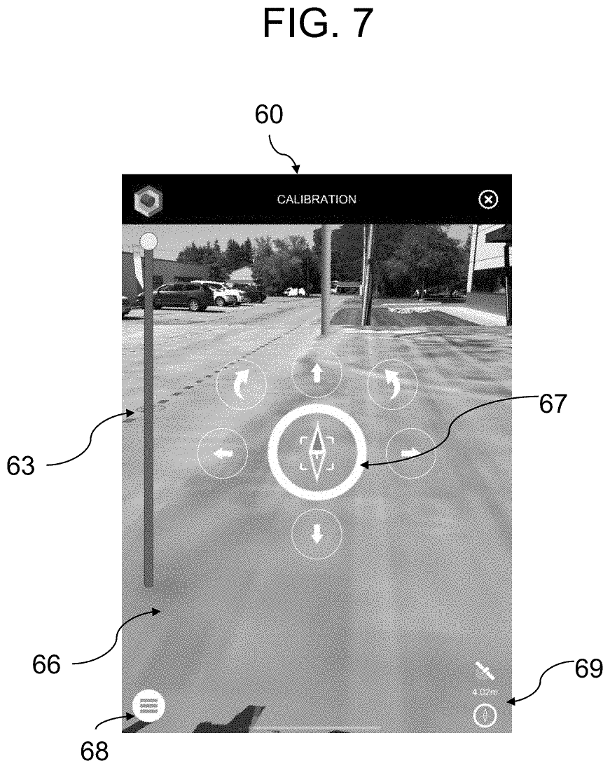

Referring to FIGS. 6A-6B, and 7, the present disclosure further provides for a calibration tool 60 and method. The calibration tool 60 can be configured to load one or more assets 61 around one or more known assets, like utility lines 62, 63, and 64, with a known latitude and longitude. For example, a user can select an augmented representation of a virtual hydrant 61, stand directly over top of that virtual hydrant 61 using the mobile device and load all other assets 62, 63, and 64 around that point. Since the latitude and longitude of the hydrant 61 is known, everything else can be displayed in relation to that known point, as opposed to using the GPS coordinates on the phone or tablet. FIG. 6B allows for a top side view for added asset visualization. A calibration method associated with the tool 60, as shown in FIG. 6B, allows a point 65 on two distinct features in a display 60A of the top side augmented reality view and then align those points 65 with their two-dimensional (“2D”) representation on a 2D map. This accurately aligns the augmented reality visuals with the real-world horizontal alignment and rotational alignment.

As seen in FIG. 7, the calibration method of the present disclosure can allow for loading of satellite imagery and overlaying that imagery on a ground surface 66. This allows adjustment of the augmented reality view to lineup with the real-world view. This also verifies the horizontal and rotational alignment between the virtual world and the real-world. Directional symbols 67 can be provided to assist with visualization. The 2D imagery displayed on the ground surface 66 and aligned with the real-world image from the device's camera can be seen. The tool 60 provided on a mobile application can include a menu button 68 and a data indicator 69.

In another example, other applications for this technology could include the display of emergency response crews in augmented reality over top of a live camera feed from a drone. Or the display of these same above ground and below ground assets over top of a live camera feed from a drone.

The present disclosure further provides for a system that also includes the ability to use image recognition and text recognition to accurately place a 3D model in a real-world display. By placing markings, whether that be paint, flags, stakes or the like, the system configured to use artificial intelligence (“AI”) and machine learning to recognize these markings. Text may be placed near these markings containing geographic information, such as latitude and longitude. The text may be written with paint, markers, printed media or another source that can be recognized by a text recognition engine. In this way the system is able to determine the latitude and longitude of the markers that have been placed in the real-world. That information can then be used to calculate relative positions to the assets and used to generate a 3D model of the assets around those markers that were identified.

It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

What is claimed is:

1. An augmented reality (AR) system for visualizing, displaying, and management of utility assets comprising:
(a) a mobile device having a display, a camera, a processor, a controller, and a wireless communication module, the display coupled to the camera configured for displaying a base image aview from the camera;
(b) a mobile application hosted on the mobile device and configured to be executed by the controller for processing asset data including at least one of location, identification, and depth data of the asset, the asset data corresponding to one or more existing assets surrounding a location of the mobile device, wherein the asset data corresponds to one or more utility lines and the mobile application is configured for determining relative distance data from the mobile device to the asset and generating an overlay image as an AR image viewable through the display over the base image;
(c) indicia for indicating identity and location of the asset corresponding to the processed location data and overlayed on the display, wherein the indicia include dashed, colored, solid lines, and shapes corresponding to virtual assets; and
(d) a function menu configured to be accessed on the display to optionally add virtual overlays on the display including a virtual asset.

2. The AR system of claim 1, wherein the controller is configured to be updated with location and view data in real-time to adjust for the corresponding relative distance from the mobile device and the asset.

3. The AR system of claim 1, wherein the display is a touchscreen of a smart phone, a smart tablet, or a mobile computer and the camera is integrated or external to the mobile device.

4. The AR system of claim 1, wherein the asset data includes geospatial location data.

5. The AR system of claim 1, further comprising a calibration tool.

6. The AR system of claim 5, wherein the calibration tool is configured to align for orientation of the overlay image with corresponding real objects provided on the display.

7. The AR system of claim 1, wherein the mobile application is configured to allow for manual or remote data input to update location data of the asset.

8. The AR system of claim 1, wherein the mobile application is configured for inputting virtual assets onto the display for determining feasibility and functionality of the virtual asset in cooperation with an existing location and utility line.

9. The AR system of claim 1, wherein the mobile application, using the wireless communication module, is configured to wirelessly communicate location and distance data associated with virtual assets.

10. The AR system of claim 1, wherein hidden and unhidden assets are visible on the overlay image and hidden utility lines are shown in both solid and dashed lines.

11. The AR system of claim 10, wherein hidden water lines are virtually displayed and overlayed in solid and dashed blue lines, hidden gas lines are displayed and overlayed in sold and dashed yellow lines, and hidden electric lines are displayed and overlayed in solid and dashed red lines, on an image view in real-time on the display.

12. The AR system of claim 1, wherein the hidden asset includes location and depth data as an AR image showing a solid line and a corresponding dashed line of a matching indicia to provide relative perspective to actual location above ground identification.

13. The AR system of claim 1, further including depth indicators connected to a virtual asset indicia.

14. The AR system of claim 1, further including a functional menu accessible on the display for generating a measuring tool, a calibration tool, or a virtual asset to be overlayed on the display.

15. The AR system of claim 1, wherein the overlay display is configured to be adjusted in real-time responding to positioning of the camera relative to its position in the base image.

16. The AR system of claim 15, wherein the camera and the mobile application are configured for detecting a ground surface to maintain a continuous visual display of the hidden asset.

17. The AR system of claim 1, wherein the mobile application includes computer vision algorithms executed on the controller to generate a 3D model of the camera within its surroundings and further includes computer vision configured to track movement of the camera and the camera position relative to a location of the camera for tracking camera location and orientation relative to the surrounding objects.

18. The AR system of claim 17, wherein the 3D model corresponds to the base image and tracks detected points within the image, the relative position of those points from each other, and is configured to track those points as the computer vision algorithms compares the points from frame to frame to the points in the base image at a frame refresh rate.

19. The AR system of claim 1, further including an annotation, drawing object, and note tool configured to allow manual inputs to be provided on the display and the overlayed AR image.

20. The AR system of claim 1, wherein the mobile application is configured to identify and track points on real objects in the base image relative to the camera.
